(19) United States
(12) Patent Application Publication
(10) Pub. No.: US 2006/0250807 A1
(43) Pub. Date: Nov. 9, 2006

(54) 2 Pc surface mount lighting fixtures

(76) Inventor: Paul D. Crunk, Taylor, MI (US)

Correspondence Address: Paul Crunk, 12220 WOODCREST BOX 725, TAYLOR, MI, 48180, US

(21) Appl. No.: 11/121,724

(22) Filed: May 5, 2005

(51) Int. Cl. F21V 17/06

(52) U.S. Cl. 362/434; 362/389

(57) ABSTRACT

A 2 pcs mounting fixture made of any type of material to hold new or existing lighting in or on a vehicle or non vehicle applications, where the ease of installation can be cut by about 95% thus eliminating the need for extra work in cutting large holes in the mounting surface inside or outside a vehicle of non vehicle application. The 2 pc mounting fixture will hold the light or lamp securely in place preventing it from rattling or shifting by using the clamping action of the two pcs and having notches or tabs that will match the light to the mounting fixture.

### BACKGROUND OF INVENTION

Mr. Paul Crunk conceived the idea after many years of experience in manufacturing LED lighting for commercial trucks and trailers and homes where light went into standard plastic recessed flanges and a recessed rubber grommets, where he found a need for a simple surface mount type fixture that could accept different models pf lights offered by all types lighting manufactures and have them all fit in a surface mount fixture designed for each shape of light, round, oval, square or rectangle.

To this present-day there is not much of a choice and availability in lighting fixtures besides using standard plastic recessed mounting flanges and rubber grommets in vehicle used as interior lighting in trucks, trailers motor homes and campers etc., used as stop, tail, turn or interior or exterior lighting, or recessed cans in the non vehicle applications to mount existing lighting used in commercial and residential applications. The problem with these types of vehicle mounting fixtures are, if you have a vehicle that does not have the depth to mount a flush mount type flange or rubber grommets than you cannot use a 4″ inch round or 6.5″ oval lamp or any other types of existing lighting on the market. One of the major problems with trailer manufacturers is there is no depth in the ceiling to be able to mount the light or lamp in a flush Mount flange or rubber grommet. This is where a surface mount fixture can be used which can accommodate all types and models of existing lighting to fit into a two-piece surface mount fixture which then can be mounted vertically or horizontally holding the lamp securely in place and without drilling any massive holes in the vehicle or non vehicle application to mount incandescent, LED or florescent lighting. This 2 pc surface mount fixture can also be used on non vehicle application as in homes, apartment and any outdoor structure without having to cut hole in the surface to be able to mount a DC or AC light.

### BRIEF SUMMARY OF THE INVENTION

The present invention provides the easiest and most advanced way of mounting all types of existing lighting being manufactured worldwide and having them held securely in place in a two-piece mounting fixture, which allows the lamp/ lights to be placed in or removed easily from the mounting fixture have matching cutouts to match the lamp size exactly so there will be no sloppy or non fitted type of installations. Having a surface mount type of mounting fixture will allow manufacturers an easy way of installation and mounting standard or other types of high technology lighting in vehicle or non vehicle applications. With the use of the two-piece mounting fixture it will allow greater ease of the owner, or service person to install, service or replace existing lights/lamps in all types of vehicle or non vehicle applications by only having to remove the screws that are inserted into the mounting holes (5) that sandwiches of the upper and lower fixture together holding the light securely. With a two-piece mounting fixture it can be mounted vertically or horizontally providing a secure means of holding the light in the mounting fixture and having the fixture securely fastened to the mounting surface using one or more screws that would be inserted in the mounting fixture hole allowing the user, the assembly installer or service technician a better way of mounting servicing existing lighting without drilling or having to cut large holes in the mounting applications.

### BRIEF DESCRIPTION OF THE DRAWINGS

FIG. 1. This drawing is showing top mounting fixture (2) that will slip over top of bottom fixture (1) that will hold the light (10) securely in place setting on the mounting ledge (4) in the bottom fixture (1) and the upper mounting holder (3) sandwiching the light securely between the upper holder (3) and the lower light mounting ledge (4) keeping the light tightly fitted between the upper fixture (2) and the lower fixture (1) being held tightly closed when inserting screws into the holes (5) which allows the assembled mounting fixtures (1) and (2) to be held securely together onto any type of mounting surface (12) providing an easy tightly held installation of incandescent, LED or florescent type of lighting.

FIG. 2. This drawing is showing the bottom mounting fixture (1) which will hold a light or lamp (10) setting on the mounting ledge (4) and any special lighting tabs or shape will insert into the notch (7) or (8) allowing the light or lamp to fit tightly in place in the molded cutouts which can be designed to fit any type of lighting application worldwide for the purpose of surface mounting. When the bottom fixture (1) holding the light (10) on the ledge (4) has the top mounting fixture (2) placed over top of the light (10) which at that point will be sandwiching the lamp or light between the top (2) and bottom mounting fixtures (1) holding the light securely between the top and bottom mounting fixtures when inserting the screws through the mounting holes (5) of both the top and bottom mounting fixtures securely holding everything to the mounting surface (12) of the application.

FIG. 3 This is a blown up view of the light (10) being held tightly in place by the upper mounting fixture (1) holder (3) and the lower mounting fixture (2) ledge (4) showing the holes (5) for screws to go through in the upper mounting fixture and the lower mounting fixture.

FIG. 4 A drawing showing the Light (10) with a fluorescent tube (9) being held in the upper fixture (2) and the lower fixture (1) clamping the light or lamp between both the upper and lower sections at (4) having mounting holes (5) in both the upper and lower fixtures when mounted will pull both the upper (2) and lower (1) fixtures together griping the light or lamp inside at the fixture point (4) holding it securely.

FIG. 5 A two-piece surface mounting fixture (2) holding an example of a fluorescent light (10) to a vertical surface (12) in this drawing which can be vehicle or non vehicle applications.

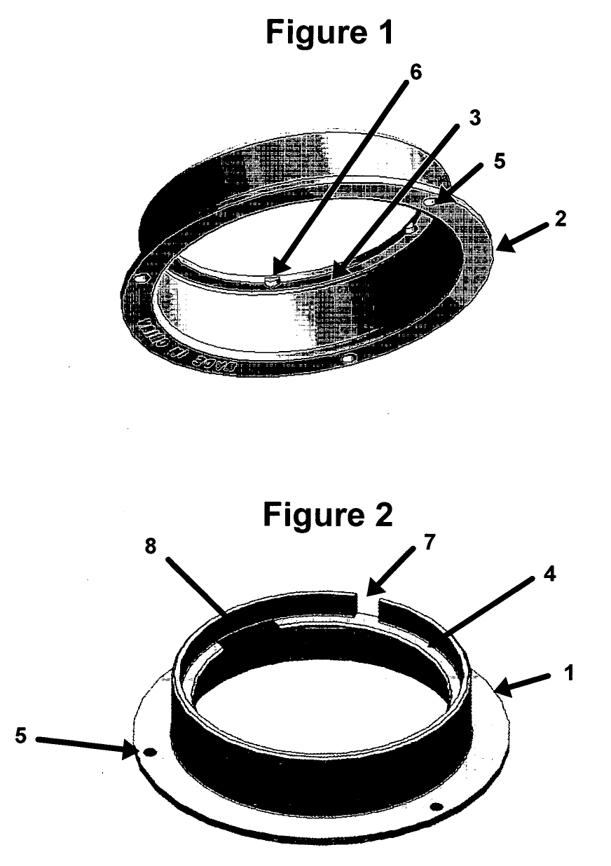

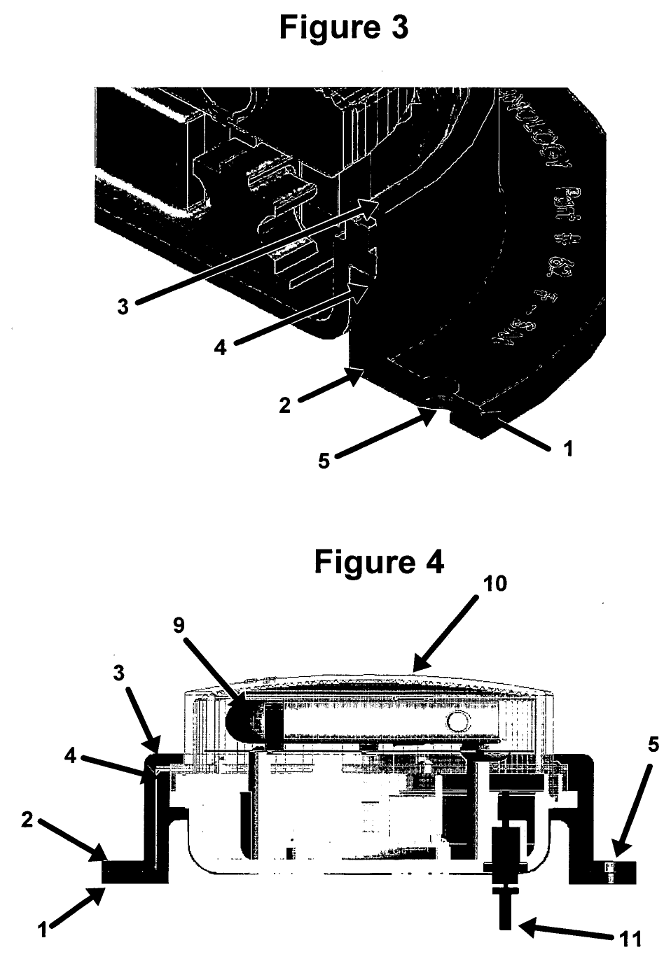

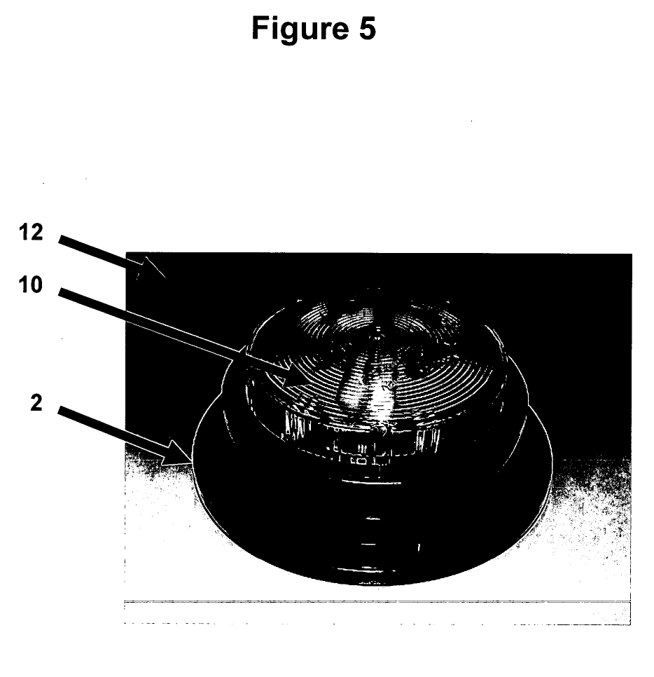

### DETAILED DESCRIPTION OF THE INVENTION

This invention is a better way of mounting existing types of incandescent, LED and florescent lighting to a mounting surface without having to cut any holes a vehicle or non vehicle surfaces inside or outside of homes or business applications where a light/lamp is needed to illuminate an area were light can be projected out, downwards or upwards for any type or sort industrial or consumer type of application. This two-piece type of mounting fixture can be easily used inside or outside of trucks, trailer, motor-homes, campers, fifth wheel, utility boxes, fire truck applications, utility trailers, trailers, underbody lighting, headlights taillights backup lights, utility lights, service lights, strobe lights, beeken lights or any other type of lamp or lighting application that needs to be mounted to any type of surface application without having to cut or drill any large holes in the mounting surface. There are many convenient features of this two peace mounting fixture that will allow manufacturers of the mentioned above applications the ease of a simple installation of any type of lamp configuration matching the configuration of the two-piece mounting fixture thereto be installed into. The two-piece mounting fixture can be made into any shape or form to match the lamps or lights needing to be installed and any viewing angle vertically horizontally downwards or upwards.

What is claimed:

1. A two-piece mounting fixture that will hold various types of lighting being manufactured worldwide, which will fit into the shape of the two-piece mounting fixture, which will hold that lamp or light securely in place by sandwiching the light or lamp between the upper and lower mounting fixtures.

2. A two-piece mounting fixture of any shape or size to hold the lamp or light in any design shape or size matching the mounting fixture which will hold that light securely in place by the sandwiching effect between the upper and lower mounting fixtures when mounted to any application using different type of fasteners.

3. A two-piece mounting fixture with notches, tabs or cutouts of any shape or size being made of any type of material to hold lamp securely between the two mounting fixtures with securing the fixture to the mounting service creating a sandwiching effect between the upper and the lower mounting fixtures securing the lamp or light in place from rattling or movement in any form or way when mounted to any application of use using fasteners.

4. Dependent on claim one, a two-piece mounting fixture of any color including any color of plating of any shape or size allowing existing and new types of lighting to be easily mounted to a vehicle or non vehicle applications to be used in low or high-voltage applications allowing OEMs, installer's or consumer's easy installation without having to cut large holes in the mounting surface thereto be in installed when mounted to any application of use using fasteners.
